(19) United States
(12) Patent Application Publication
(10) Pub. No.: US 2026/0295866 A1
(43) Pub. Date: Oct. 1, 2026

(54) GRIPPING DEVICE AND ROBOT HAVING A GRIPPING DEVICE

(71) Applicant: Kendrion (Donaueschingen/Engelswies) GmbH, Donaueschingen (DE)

(72) Inventor: Peter DECKEL, Volkertshausen (DE)

(21) Appl. No.: 19/564,856

(22) Filed: Mar. 12, 2026

(30) Foreign Application Priority Data
Mar. 28, 2025 (DE) 102025112290.3

(51) Int. Cl. B25J 15/02

(52) U.S. Cl. CPC B25J 15/024

(57) ABSTRACT

A gripping device for gripping an article, in particular an electromagnetic gripping device for a robot, includes a solenoid with a magnet housing and a gripping unit. An armature movable in a longitudinal axis and an electromagnetic excitation system for actuating the armature are arranged in the magnet housing. The gripping unit has an actuating rod movable in the longitudinal axis and at least one finger movable about a pivot axis. The at least one finger is mechanically coupled to the actuating rod such that the movement of the actuating rod is converted to a pivoting movement of the at least one finger for gripping the article. The gripping unit is arranged in the longitudinal axis on the magnet housing and the actuating rod is mechanically connected to the armature. Furthermore, a robot has such a gripping device.

The present invention relates to a gripping device, in particular an electromagnetic angular gripper for a robot, for gripping an article having the features of claim 1. Furthermore, the present invention relates to a robot, in particular an articulated arm robot, having the features of claim 18.

Gripping devices are known in various designs from the prior art. Such gripping devices are widely used in the prior art to handle articles during automated processing, for example to reliably pick them up and put them down. Each gripping device comprises at least one finger that can be moved using an actuating device in order to grip the article. In the prior art, gripping devices are subdivided into parallel grippers, centric grippers or angular grippers, wherein typically the at least one finger of parallel and centric grippers is moved translationally and the at least one finger of angular grippers is moved rotationally, that is, pivoted.

For example, a pneumatic angular gripper is known from DE 10 2004 038 261 A1, wherein the angular gripper has two fingers which are pivoted in opposing rotational directions to grip the article.

Such gripping devices have proven themselves in the past. Especially in automated manufacturing, fast and reliable gripping of articles of all sizes, with a wide variety of geometries and in any environment, is required to optimize processes.

This is where the present invention comes in.

The present invention is dedicated to the object of providing a suitably improved gripping device, in particular an electromagnetic angular gripper, for a robot, which device in particular enables particularly fast and reliable gripping of articles.

These objects are achieved using a gripping device with the features of claim 1 and a robot with the features of claim 18.

Further advantageous embodiments of the present invention are specified in the dependent claims.

The inventive gripping device, in particular the inventive electromagnetic angular gripper for a robot, for gripping an article having the features of claim 1 has a solenoid with a magnet housing and a gripping unit with at least one finger that can be actuated by the solenoid.

An armature movable in a longitudinal axis and an electromagnetic excitation system for actuating the armature are also arranged in the magnet housing.

Furthermore, the gripping unit comprises an actuating rod movable in the longitudinal axis and the at least one finger movable about a longitudinal axis, wherein the at least one finger is mechanically coupled to the actuating rod such that the movement of the actuating rod is converted to a pivoting movement of the at least one finger about the pivot axis for gripping the article.

Furthermore, the gripping unit is arranged in the longitudinal axis on the magnet housing and the actuating rod is mechanically connected to the armature.

The present invention is based on the idea of proposing a modular gripping device, in particular a modular angular gripper, having a gripping unit that can be actuated by a solenoid. Solenoids are maintenance-free compared to pneumatic actuating devices and feature an extremely compact design with low power consumption, high forces and extremely short switching times. In particular, the very short switching times allow the cycles to be shortened, and the high forces ensure safe handling of the articles.

The proposed gripping device allows for the use of a large number of identical parts for different applications. The main focus is on using a conventional solenoid. The gripping unit is arranged as a module, having the at least one finger, on the magnet housing of the solenoid. This allows identical solenoids to be used for different applications, and only the gripping unit with its article-specific at least one finger or even just the finger can be exchanged, giving the proposed gripping device significant technical and cost advantages over known gripping devices.

According to further developments, it is advantageous if the gripping unit has a distal side along the longitudinal axis and a proximal side opposing the distal side. The at least one finger is preferably arranged on the distal side. The at least one finger preferably projects from the distal side of the gripping unit.

It is also further preferred if the gripping unit is arranged with its proximal side against the magnet housing, in particular attached with its proximal side to the magnet housing. For example, the gripping unit can include a gripper housing that can be attached to the magnet housing.

Furthermore, it is advantageous if at least two fingers are provided. The at least two fingers are preferably arranged rotationally symmetrically about the longitudinal axis and/or the actuating pin and are further preferably pivotable in opposing directions in order to be able to grip the article.

According to a further development of the present invention, the at least one finger comprises a catch via which the at least one finger is mechanically coupled to the actuating rod. The catch of the at least one finger is preferably coupled to the actuating rod in a form-fit and/or friction-fit. The mechanical coupling between the catch and the actuating rod ensures direct and reliable transmission of the movement of the actuating rod to the at least one finger. In particular, reliable conversion of the translational movement of the actuating rod to rotational movement of the at least one finger is ensured.

Furthermore, it has proven advantageous if the at least one finger is movably mounted, especially pivotably mounted, on the gripping unit and in particular on the gripper housing. In particular, it is advantageous if the at least one finger is arranged in a recess of the gripper housing and is rotatably mounted in the recess on the gripper housing by means of a swivel joint. This results in a compact and robust design.

Furthermore, it has proven advantageous if the at least one finger is designed as a lever which includes a catch and a holding means for holding the article. For example, it may be advantageous if the catch is arranged at one end of the lever and the holding means is arranged at the other end, wherein the pivot axis is preferably arranged between the catch and the holding means.

The holding means can preferably be adapted to the respective article in order to grip the article securely.

It has also proven advantageous if the at least one finger is designed as a two-sided lever that includes the catch on one side at a first distance from the pivot axis and the holding means on the other side at a second distance from the pivot axis.

It has also proven advantageous if the second distance is greater than the first distance, which allows for a particularly fast movement of the at least one finger for opening or closing.

Furthermore, it has proven advantageous if the lever is L-shaped. The L-shaped design of the at least one finger, designed as a lever, allows for a particularly compact and slim construction.

A further development of the present invention provides that the actuating rod comprises a groove, and that the at least one finger engages in the groove. The actuating rod is preferably rotationally symmetrical and even more preferably the groove is designed as a circumferential radial groove. This makes it possible for the actuating rod to be a simple and cost-effective component that can be manufactured by turning, for example.

A further development of the present invention provides that the actuating rod is mechanically connected directly to the armature or is connected to the armature by means of an armature rod. For example, it is advantageous if the mechanical connection between the actuating rod and the armature includes a screw and/or press connection. In particular, it is preferred if the actuating rod is screwed into the armature and has the circumferential radial groove. This allows the assembled gripping unit with the actuating rod and the at least one finger coupled to the actuating rod to be placed onto the solenoid and the actuating rod to be screwed to the armature, wherein the actuating rod, when being screwed in, is freely rotatable relative to the at least one finger.

A further development of the present invention provides that the gripping unit, in particular the gripper housing of the gripping unit, has a receiving portion, and that the solenoid projects along the longitudinal axis into the receiving portion of the gripping unit. The receiving portion is preferably a hollow cylinder and the gripping unit can at least partially enclose the solenoid, wherein the armature preferably projects into the receiving portion of the gripping unit. This allows for a particularly short and compact design.

Furthermore, it has proven advantageous if the armature can be arranged in a stroke start position and a stroke end position, and that the armature is moved into the stroke end position when the electromagnetic excitation system is actuated, in particular when the excitation coil of the electromagnetic excitation system is energized along the longitudinal axis. It is particularly advantageous if the armature is moved from the stroke start position into the stroke end position against the force of a return spring, wherein the return spring is preferably arranged inside the magnet housing.

A further development of the present invention provides that the armature is moved away from the stroke start position into the stroke end position by the gripping unit, in particular the gripper housing. This draws the actuating rod into or towards the magnet housing, enabling a particularly compact design.

It is also advantageous if the magnet housing has a distal side along the longitudinal axis and a proximal side opposing the distal side. The gripping unit and in particular the gripper housing are arranged along the longitudinal axis on a distal side of the magnet housing and are further preferably connected thereto.

Furthermore, it is advantageous if the gripping device includes a mounting flange. The mounting flange is preferably arranged along the longitudinal axis on the proximal side of the magnet housing.

The solenoid or the magnet housing is therefore located spatially between the mounting flange and the gripping unit and forms a mechanical connection between the mounting flange and the gripping unit.

According to a further development, the mounting flange is connected to the proximal side of the magnet housing and may also have fastening means suitable for attaching the mounting flange to the robot arm or cobot. The mounting flange is used to connect the gripping device to a robot arm and can connect the magnet housing to the robot arm.

According to a preferred embodiment, the mounting flange can be partially hollow, in particular a hollow cylinder. For example, the mounting portion can include a cut-out, wherein the armature rod or the armature of the solenoid can dip into the cut-out in the stroke end position. Accordingly, it is preferred if the cut-out is located on the side facing the magnet housing.

Another aspect of the present invention relates to a robot, in particular an articulated arm robot, for example a cobot, having a gripping device described above.

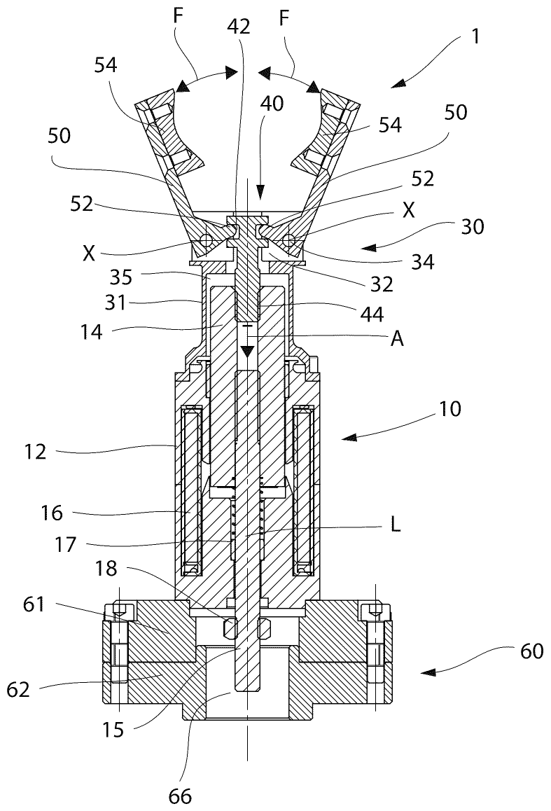

FIG. 1 shows a partially cutaway view of an exemplary embodiment of an electromagnetic gripping device 1, in particular an angular gripper, for a robot (not shown) for gripping an article (not shown).

The gripping device 1 is modular in design and comprises a solenoid 10, a gripping unit 30 and a mounting flange 60. The solenoid 10 is arranged as a central module between the mounting flange 60 and the gripping unit 30 and mechanically connects the mounting flange 60 to the gripping unit 30.

The proposed gripping device 1 makes it possible to use a conventional solenoid 10 unchanged and to adapt only the gripping unit 30 and the mounting flange 60 to the specific application.

The gripping device 1 has a longitudinal axis L, wherein the longitudinal axis L essentially corresponds to an axis of symmetry of the gripping device 1.

The solenoid 10 is designed in a known manner and comprises a magnet housing 12 designated as a whole, an electromagnetic excitation system with an excitation coil, a return spring 17, an armature 14 and an armature rod 14.

Along the longitudinal axis L the solenoid 10 has a distal side and a proximal side opposing the distal side.

The magnet housing 12 can have a through-opening from which the armature 14 protrudes distally and the armature rod 15 proximally.

The armature 14, movable along the longitudinal axis L, the return spring 17 and the electromagnetic excitation system 16 for actuating the armature 14 are arranged in the magnet housing 12 or in the through-opening of the magnet housing 12.

The armature rod 14 is movably mounted on the magnet housing 12 or in the through-opening of the magnet housing 12.

The armature 14 can be arranged in a stroke start position (shown in FIG. 1) and in a stroke end position (not shown). When the electromagnetic excitation system 16 is actuated, i.e., when the excitation coil is energized, the armature 14 is moved along the longitudinal axis L into a stroke end position against a restoring force of the return spring 17.

For this purpose, the return spring 17 is arranged in the through-opening of the magnet housing 12 and is arranged between the magnet housing 12 and the armature 14 on the armature rod 15 and is supported at one end on the magnet housing 12 and at the other end on the armature 14.

The armature 14 is securely connected to the armature rod 15 and the armature 14 is held movable in the through-opening of the magnet housing 12 by the armature rod 15. The armature rod 15 can have an end stop 18 with which the stroke start position can be established. The end stop 18 rests against the magnet housing 12 in the stroke start position.

The proximal side of the solenoid 10 is connected to the mounting flange 60, via which a connection to a robot (not shown), in particular a robot arm of an articulated arm robot, can be established.

In the exemplary embodiment, the mounting flange 60 has a cut-out 66 along the longitudinal axis L to accommodate the armature rod 15 and/or the end stop 18 projecting from the magnet housing 12, preferably in a freely movable manner, both in the stroke start position and in the stroke end position.

The mounting flange 60 can be designed in two parts, as indicated in the FIGURE. A first mounting flange part 61 is connected to the solenoid 10 and a second mounting flange part 62 can be connected to the robot. The first mounting flange part 61 and the second mounting flange part 62 can be connected to each other by means of a screw connection, for example.

The gripping unit 30 comprises a gripper housing 31, designated as a whole, an actuating rod 40 and two fingers 50.

Along the longitudinal axis L, the gripping unit 30 has a proximal side and a distal side opposing the proximal side.

The gripping unit 30 is arranged on the distal side of the solenoid 10 and the gripper housing 31 is connected to the magnet housing 12.

Along the longitudinal axis L, the gripper housing 31 has an opening in which the actuating rod 40 is arranged.

Furthermore, on the proximal side of the gripping unit 30, the gripper housing 31 has a pot-shaped receiving portion 35 into which the solenoid 10, or more precisely the armature 14 of the solenoid 10, projects along the longitudinal axis X.

On the distal side of the gripping unit 30, the gripper housing 31 has, on the side opposing the longitudinal axis L, a recess 32 in which a finger 50 is mounted pivotable about a pivot axis X, preferably on a pivot pin 34.

The actuating rod 40 is movable in the gripper housing 31 along the longitudinal axis L.

The actuating rod 40 can be essentially rotationally symmetrical and comprises a groove 42 and a fastening means (not shown) for establishing a mechanical connection to the armature 14.

The actuating rod 40 is connected to the armature 14 along the longitudinal axis L on the side of the armature 14 opposing the armature rod 15.

The groove 42 is designed as a circumferential radial groove. The groove 42 is preferably formed distally on the actuating rod 40 and the fastening means proximally.

The fastening means preferably includes a thread for establishing a screw connection 44 between the armature 14 and the actuating rod 40.

The two fingers 50 are arranged about the actuating rod 40 in the respective recess of the gripper housing 31 and project freely from the gripper housing 31 in the longitudinal axis L. The two fingers 50 are essentially identical in construction, which is why only one finger 50 is described below.

The finger 50 is movable about the pivot axis X, wherein the pivot axis X is oriented transverse and spaced apart from the longitudinal axis L.

The finger 50 is mechanically coupled to the actuating rod 40 such that the movement of the actuating rod 40 is converted into a pivot movement of the respective finger 50 for gripping the article.

The finger 50 is designed as a two-sided lever and comprises a catch 52 and a holding means 54. The catch 52 is arranged at one end on the finger 50 and the holding means 54 at the other end, wherein the pivot axis X is arranged between the catch 52 and the holding means 54.

The catch 52 can have a rounded head and engages in the groove 42 of the actuating rod 40 and mechanically couples the finger 50 to the actuating rod 40. The catch 52 is held in the groove 42 in a form-fitting manner.

The catch 52 is arranged at a first distance A1 from the pivot axis X and the holding means 54 is arranged at a second distance A2 from the pivot axis X, wherein the second distance A2 is greater than the first distance A1, that is, A2>A1.

The holding means 54 can have soft jaws that allow for gentle gripping of the article. The holding means can also be adapted to the shape of the article in any way to ensure safe handling.

To assemble the gripping device 1, the gripping unit 30 with the actuating rod 40 and the finger 50 engaging in the actuating rod 40 is first arranged on the proximal side of the solenoid 10 and the actuating rod 40 is screwed to the armature 14. By designing the groove 42 as a circumferential radial groove, the actuating rod 40 can be freely rotated relative to the fingers 50 while it is being screwed in.

The mounting flange 60, the magnet housing 12, the armature 14, the armature rod 15, the actuating rod 40 and the gripping unit 30 are arranged along the longitudinal axis L, as shown in the FIGURE, preferably coaxially.

The accompanying FIG. 1 shows the gripping device 1 for gripping the article in the unactuated, that is, open, state. In this state, the electromagnetic excitation system is de-energized and the armature 14 is in the stroke start position.

When the electromagnetic excitation system is energized, the armature 14 is moved against the force of the return spring 17 along the longitudinal axis L into the stroke end position and the actuating rod 40 is moved along the longitudinal axis L by the armature 14, this stroke movement being indicated in the accompanying FIGURE by an arrow and the reference symbol A.

Due to the form fit between the actuating rod 40 and the fingers 50, more precisely between the groove 42 and the catches 52, the catches 52 are also moved along the longitudinal axis L, causing the two fingers 50 to pivot synchronously and in opposing directions about the pivot axis X. This pivoting movement is indicated in the accompanying FIGURE by a double arrow and the reference symbol F.

The gripping device 1 is now closed and the article can be held clamped between the fingers 50.

To return to the unactuated, that is, open, state of the gripping device 1, the current to the electromagnetic excitation system is reduced or terminated. The armature 14 is moved back to the stroke start position by the return spring 17. The fingers 50 move apart about the pivot axis X and the article can be released.

### LIST OF REFERENCE SYMBOLS

1 Gripping device
10 Solenoid
12 Magnet housing
14 Armature
15 Armature rod
16 Excitation system
17 Return spring
18 End stop
30 Gripping unit
31 Gripper housing
32 Recess
34 Pivot pin
35 Receiving portion
40 Actuating rod
42 Groove
50 Finger
52 Catch
54 Holding means
60 Mounting flange
61 First mounting flange part
62 Second mounting flange part
66 Cut-out
A Stroke movement
F Pivot movement
L Longitudinal axis
X Pivot axis

1. A gripping device (1), in particular an electromagnetic angular gripper for a robot, for gripping an article, comprising
a solenoid (10) with a magnet housing (12) and
a gripping unit (30),
wherein an armature (14) movable in a longitudinal axis (L) and an electromagnetic excitation system (16) for actuating the armature (14) are arranged in the magnet housing (12),
wherein the gripping unit (30) comprises an actuating rod (40) movable in the longitudinal axis (L) and at least one finger (50) movable about a pivot axis (X),
wherein the at least one finger (50) is mechanically coupled to the actuating rod (40) such that the movement of the actuating rod (40) is converted to a pivoting movement of the at least one finger (50) for gripping the article,
wherein the gripping unit (30) is arranged on the longitudinal axis (L) on the magnet housing (12) and
wherein the actuating rod (40) is mechanically connected to the armature (14).

2. The gripping device (1) according to claim 1, characterized in that the at least one finger (50) comprises a catch (52) using which the at least one finger (50) is mechanically coupled to the actuating rod (40).

3. The gripping device (1) according to claim 1, characterized in that the at least one finger (50) is mounted so as to be pivotable.

4. The gripping device (1) according to claim 1, characterized in that the at least one finger (50) is designed as a lever comprising the catch (52) and a holding means (54) for gripping the article.

5. The gripping device (1) according to claim 1, characterized in that the at least one finger (50) is designed as a two-sided lever (52) which comprises the catch (52) on one side at a first distance from the pivot axis (X) and the holding means (54) on the other side at a second distance from the pivot axis (X).

6. The gripping device (1) according to claim 1, characterized in that the second distance is greater than the first distance.

7. The gripping device (1) according to claim 1, characterized in that the lever is L-shaped.

8. The gripping device (1) according to claim 1, characterized in that the actuating rod (40) comprises a groove (42) and in that the at least one finger engages in the groove (42).

9. The gripping device (1) according to claim 1, characterized in that the actuating rod (40) is directly connected to the armature (14) or mechanically connected to the armature (14) by means of an armature rod (15).

10. The gripping device (1) according to claim 1, characterized in that the mechanical connection between the actuating rod (40) and the armature (14) is a screw and/or press connection.

11. The gripping device (1) according to claim 1, characterized in that the gripping unit (30) has a receiving portion (35) and in that the solenoid (10) projects into the receiving portion (35) along the longitudinal axis (L).

12. The gripping device (1) according to claim 1, characterized in that the armature (14) can be arranged in a stroke start position and in a stroke end position, and in that the armature (14) is moved along the longitudinal axis (L) into the stroke end position when the electromagnetic excitation system is actuated.

13. The gripping device (1) according to claim 1, characterized in that the armature (14) is moved from the stroke start position into the stroke end position against the force of a return spring (17).

14. The gripping device (1) according to claim 1, characterized in that the armature (14) is moved by the gripping unit (30) away from the stroke start position into the stroke end position.

15. The gripping device (1) according to claim 1, characterized in that the gripping unit (30) is connected along the longitudinal axis (L) on a distal side to the magnet housing (12).

16. The gripping device (1) according to claim 1, characterized in that a mounting flange (60) is arranged along the longitudinal axis (L) on a proximal side of the magnet housing (12) and is connected on one side to the magnet housing (12) and on the other side has fastening means for attaching to the robot.

17. The gripping device (1) according to claim 1, characterized in that a mounting flange (60) is at least partially hollow.

18. A robot (2), in particular an articulated arm robot, having an electromagnetic gripping device (1), in particular an electromagnetic angular gripper, according to claim 1.
